(19) United States
(12) Patent Application Publication
(10) Pub. No.: US 2026/0244168 A1
(43) Pub. Date: Aug. 20, 2026

(54) Adaptive Multi-Tier AI System with Hierarchical Tiny LLM Architecture, Hybrid AI Mesh Network Integrating Bluetooth and Multi-Protocol Communication, Offline-to-Online AI Learning, Dual-Mode Operations, and AI-Optimized Industrial Control for Scalable Applications

(71) Applicant: XinXin Shan, Surrey (CA)

(72) Inventor: XinXin Shan, Surrey (CA)

(73) Assignee: LED Smart Inc., Surrey (CA)

(21) Appl. No.: 19/058,768

(22) Filed: Feb. 20, 2025

(51) Int. Cl. G05B 13/02

(52) U.S. Cl. CPC G05B 13/027

(57) ABSTRACT

An adaptive AI system employing hierarchical tiny LLM architecture, a hybrid AI mesh network (Bluetooth, Thread, Wi-Fi, and industrial protocols), and offline-to-online learning for robust, real-time industrial control. The invention uses dual-mode operations to switch between low-power and AI-optimized states, maximizing resource efficiency. Embedded, edge, and cloud components cooperate to deliver dynamic process control, predictive maintenance, and anomaly detection across multiple industries. This multi-tier approach enhances scalability, reliability, and adaptability, making it suitable for smart manufacturing, energy management, healthcare, military, and other mission-critical applications.

### CROSS-REFERENCE TO RELATED APPLICATIONS

### U.S. PATENT DOCUMENTS

U.S. Pat. No. 11,392,954B2 July 2022 Balayan et al.
U.S. Pat. No. 10,649,988B1 May 2020 Gold et al.
U.S. Pat. No. 11,272,034B2 March 2022 Shribman et al.
U.S. Pat. No. 12,111,859B2 November 2024 Siebel et al.
U.S. Pat. No. 11,831,620B2 November 2023 Jonytis et al.
US20250013873 January 2025 DIVAKARAN et al.

### OTHER PUBLICATION

WO2018185762A1 October 2018 BAUM et al.
WO2018071456A1 April 2018 AMINI et al.
Stouffer K et al, M (2023) “National Institute of Standards and Technology, Gaithersburg, MD”, NIST Special Publication (SP) NIST SP 800-82r3. https://doi.org/10.6028/NIST.SP.800-82r3

### BACKGROUND OF THE INVENTION

Many AI-driven control systems are hindered by high computational demands, limited real-time adaptability, fragmented communication protocols, energy inefficiency, and restricted offline processing capabilities. These shortcomings create significant barriers to deploying efficient, scalable AI solutions, especially when devices need to operate autonomously or under resource constraints.

This invention addresses these limitations by introducing a new approach that combines a hierarchical tiny LLM architecture for multi-tier AI processing, a hybrid AI mesh network for flexible multi-protocol communication, robust offline-to-online AI learning for continuous adaptation, dual-mode operations to balance power savings with intelligent decisions, and AI-optimized industrial control to dynamically adjust system parameters. The result is a versatile solution that enhances real-time responsiveness, ensures seamless connectivity, and extends the operational reach of AI-driven technologies in industrial and other critical applications.

### SUMMARY OF THE INVENTION

This invention introduces an adaptive, AI-driven industrial control system that leverages a hierarchical tiny LLM architecture alongside a hybrid AI mesh network supporting Bluetooth, Thread, Wi-Fi, and industrial protocols such as Modbus and MQTT. AI models are deployed at embedded, edge, and cloud levels, enabling a balanced distribution of computational resources to optimize real-time decision-making and overall efficiency. The system continues learning offline through autonomous local model updates and synchronizes improvements when connectivity is restored, ensuring continuous adaptation regardless of network availability. By incorporating dual-mode operations, the invention intelligently switches between an energy-saving non-AI mode and an AI-driven mode that enhances performance based on operational needs. The resulting approach enables advanced industrial control that adjusts process parameters, predicts maintenance requirements, and improves scalability, making it suitable for a wide range of mission-critical applications.

### BRIEF DESCRIPTION OF DRAWINGS

FIG. 1: System Architecture Overview

FIG. 2: Multi-Tier AI Processing Flowchart

FIG. 3: Hybrid AI Mesh Network Structure

FIG. 4: Adaptive Offline-to-Online Learning Process

FIG. 5: Industrial Control Integration Diagram

### DETAILED DESCRIPTION OF THE INVENTION

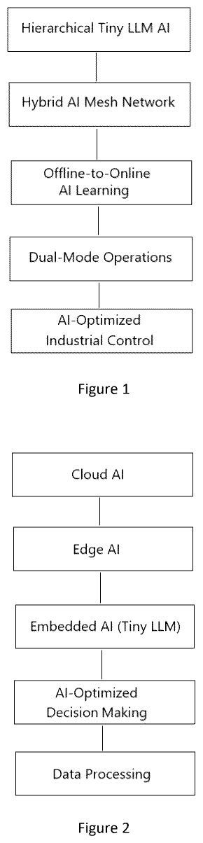

This AI-driven control system integrates hierarchical architecture, a hybrid mesh network, an offline-to-online learning framework, dual-mode operations, and AI-based industrial control. The design highlights modularity, scalability, and robust performance in dynamic industrial environments. FIG. 1 presents an overview of the system architecture, showing how hierarchical tiny LLM processing works in tandem with the mesh network and dual-mode operations to deliver efficient control in real time. Embedded devices perform rapid decision-making with lower computational overhead, while edge or cloud servers handle complex analysis and model updates.

FIG. 2 illustrates multi-tier AI processing by depicting how cloud, edge, and embedded levels coordinate tasks based on available resources. Embedded AI models focus on immediate, low-power operations, while larger-scale computations and periodic model retraining are managed at higher tiers, reducing latency for critical processes and minimizing resource consumption.

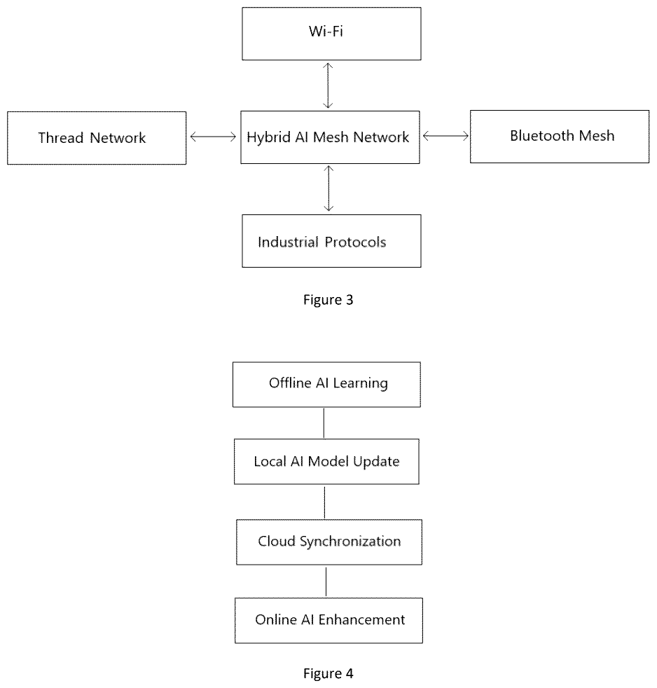

FIG. 3 demonstrates the hybrid AI mesh network, which integrates Bluetooth, Bluetooth Mesh, Thread, Wi-Fi, and industrial protocols such as MQTT and Modbus. This mesh-based infrastructure is designed to self-heal and maintain connectivity, even if individual nodes become compromised. AI-driven algorithms evaluate conditions like power availability and bandwidth demands to select the most efficient communication methods.

FIG. 4 shows the adaptive offline-to-online AI learning process, where local learning continues uninterrupted during periods of limited connectivity. Once connectivity is reestablished, local model improvements are synchronized with cloud-based systems, ensuring a unified knowledge base. This arrangement allows the invention to retain adaptability and responsiveness in environments where network stability cannot be guaranteed.

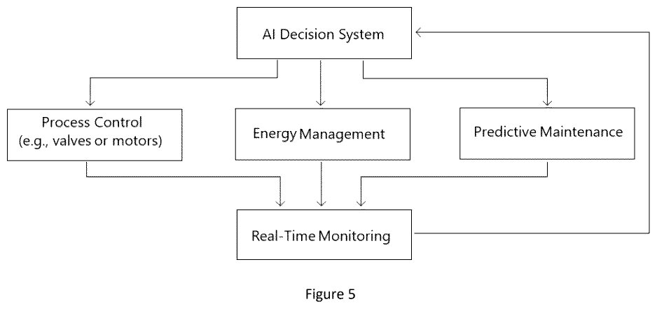

FIG. 5 depicts how AI-optimized industrial control integrates with process control, energy management, predictive maintenance, and real-time monitoring. The AI decision system refines operational parameters, detects anomalies, and schedules maintenance activities to reduce downtime. Dual-mode operations further maximize efficiency by toggling between an energy-saving non-AI mode and a resource-intensive AI mode, depending on operational demands. This dynamic approach conserves energy for essential functions while preserving the advanced decision-making capabilities required in mission-critical scenarios.

1. A non-AI Mode system comprising:
At least one embedded processing unit configured for non-AI operations;
A hybrid AI mesh network including Bluetooth, Bluetooth Mesh, Thread, Wi-Fi, and at least one industrial protocol;
A control system for managing industrial devices without AI-driven optimization.

2. The system of claim 1, wherein the non-AI operation mode is configured to minimize power consumption.

3. The system of claim 1, wherein offline-to-online learning synchronizes local and cloud-based AI models.

4. The system of claim 1, wherein predictive maintenance algorithms prevent device failures.

5. The system of claim 1, wherein the industrial control system provides remote monitoring.

6. The system of claim 1, wherein AI optimization improves operational efficiency.

7. The system of claim 1, wherein local AI models adapt based on user-defined parameters.

8. An AI Mode system comprising:
A hierarchical AI architecture with embedded, edge, and cloud-based tiny LLM processors;
An adaptive hybrid AI mesh network integrating Bluetooth, Bluetooth Mesh, Thread, Wi-Fi, and at least one industrial protocol;
A dual-mode operation for switching between AI and non-AI modes based on real-time conditions.

9. The system of claim 8, wherein the AI mode applies real-time learning for adaptive process control.

10. The system of claim 8, wherein AI-optimized industrial control dynamically adjusts device settings.

11. The system of claim 8, wherein hierarchical AI processing distributes computational loads.

12. The system of claim 8, wherein the AI framework supports real-time anomaly detection.

13. The system of claim 8, wherein the system is configured for smart city applications.

14. The system of claim 8, wherein AI-driven automation reduces energy consumption.

15. A Hybrid AI Mesh Network Integration system comprising:
A communication architecture supporting multiple protocols;
AI-driven optimization for selecting the most efficient communication method in real time;
A self-healing mesh network ensuring continuous device connectivity.

16. The system of claim 15, wherein the hybrid AI mesh network includes an automatic failover mechanism.

17. The system of claim 15, wherein the network architecture integrates MQTT for secure cloud-based communication.

18. The system of claim 15, wherein the hybrid AI mesh network includes secure encrypted communication.

19. The system of claim 15, wherein the self-healing mesh network prioritizes critical data transmission.

20. The system of claim 15, wherein communication redundancy ensures uninterrupted operation.
